(19) United States
(12) Patent Application Publication
(10) Pub. No.: US 2019/0276713 A1
(43) Pub. Date: Sep. 12, 2019

(54) Contact Adhesives

(71) Applicant: CLARIANT PLASTICS & COATINGS LTD, Muttenz (CH)

(72) Inventors: Christian STEIB, Steppach / Neusaess (DE); Erik HAUCK, Pirmasens (DE); Gerd HOHNER, Augsburg (DE); Andreas LANG, Fuerstenfeldbruck (DE); Manuel BROEHMER, Gersthofen (DE)

(73) Assignee: CLARIANT PLASTICS & COATINGS LTD, Muttenz (CH)

(21) Appl. No.: 16/342,320

(22) PCT Filed: Oct. 12, 2017
(86) PCT No.: PCT/EP2017/076015

§ 371 Date: Apr. 16, 2019

(30) Foreign Application Priority Data
Oct. 17, 2016 (DE) 10 2016 220 263.4

(51) Int. Cl. C09J 123/08; C09J 7/38

(52) U.S. Cl. CPC C09J 123/0815; C09J 7/383; C09J 2491/00; C09J 2205/114; C09J 2407/00; C09J 2467/00; C09J 2475/00; C09J 2423/00

(57) ABSTRACT

The invention relates to contact adhesive compounds containing 5 to 50 wt % copolymers of propylene having ethylene and/or having olefins, selected from the group of 1-olefins having 4 to 20 C atoms, wherein the copolymers have been produced with the aid of metallocene catalysts and are characterized by a) a flow point, measured in accordance with ASTM D97, of <50° C., b) a viscosity at 170° C. in the range from 20 to 3000 mPa·s, measured with a rotary viscometer to DIN 53019, c) a density in the range from 0.84 to 0.90 g/cm³, measured at 23° C. in accordance with ISO 1183, d) a glass transition temperature of <−35° C., measured in accordance with the DSC method according to DIN EN ISO 11357-2:2014.

The present invention relates to pressure-sensitive adhesives comprising poly-1-olefins that have been prepared with metallocene catalysts for bonding of adherends.

Pressure-sensitive adhesives (PSAs) form viscoelastic films between the adherends to be bonded. The adhesive bond, based on purely physical principles, is achieved by exerting gentle pressure on the surfaces of the adherends that have been wetted with the adhesive. The bond is generally reversible and can be parted again without destroying the substrates.

Base polymers in use for pressure-sensitive adhesives are a multitude of adhesive bases such as natural or synthetic rubbers, polyacrylates, styrene-butadiene or styrene-isobutene block copolymers, polyisobutylenes, polyesters, polychloroprenes, polyvinyl ethers or polyurethanes. These are used as pressure-sensitive adhesives in combination with resins, tackifiers and other additions. In general, pressure-sensitive adhesives also contain mineral oils, in some cases in a significant amount.

The cohesion of the pressure-sensitive adhesive system is generally determined by the base polymer; the resin and plasticizer components are primarily responsible for the adhesive effect.

Different methods are possible for the application of the pressure-sensitive adhesives to the carrier materials, for instance application from the melt, from aqueous dispersions or from the solution using organic solvents.

Pressure-sensitive adhesives have a broad spectrum of use. They are used wherever reversible bonding is desirable and where there are no high demands on strength, for example for production of adhesive tapes or insulating tapes, for self-adhesive films or labels or self-adhesive plasters, and additionally also for bonding of difficult substrates that can be bonded either not at all or only to a limited degree or after pretreatment, for example corona pretreatment.

Patent specification EP 1353997B1 describes pressure-sensitive adhesive mixtures consisting of amorphous ethylene-propylene copolymers, a “non-stereoregular” polypropylene and optionally a tackifier. The amorphous ethylene-propylene copolymers are preferably products that have not been prepared with metallocene catalysts and have glass transition temperatures between −33 and −23° C. The “non-stereoregular” polypropylenes have melt viscosities at 190° C. of more than 50 000 mPa·s and glass transition temperatures between −15 and +10° C. These are preferably polypropylene homopolymers that have been prepared with metallocene catalysts.

Application document US 2004/0127614A1 discloses pressure-sensitive adhesive formulations comprising propylene polymers prepared with metallocene catalysts and, as well as a resin component, additionally mineral oils. The latter are now considered to be risky from a toxicological point of view owing to their potential to accumulate in human tissue, and for that reason pressure-sensitive adhesives, where they are used for food packaging for example, should desirably be free of such additions (“mineral oil saturated hydrocarbons”, “MOSH”).

Beyond the prior art, there is still a need for effective pressure-sensitive adhesives that can be formulated particularly without the addition of mineral oil products.

It has been found that, surprisingly, particular polyolefins prepared with metallocene catalysts are particularly suitable for the production of pressure-sensitive adhesives, with no requirement for mineral oil additions.

It is known that products from olefin polymerization by means of metallocenes differ in various ways in their microstructure from polyolefins that have been synthesized by other insertion mechanisms, for example with the aid of Ziegler-Natta catalysts. This relates, for example, to the distribution of the monomers in the polymer chain and the molar mass distributions. However, such specific deviations generally do not permit any conclusions on any differences with regard to performance properties.

Low molecular weight amorphous copolymers of 1-olefins and ethylene that have synthesized with the aid of metallocenes are known. For instance, patent specifications EP 200351B2 and EP 586777B1 describe random copolymers of ethylene and higher 1-olefins C₃-C₂₀. Polymerization catalysts used are unbridged or bridged metallocenes of the biscyclopentadienyl type. The copolymers are suitable for use in lubricant oils.

Application document WO 2004031250 describes homogeneous, low molecular weight liquid or gel-form ethylene/α-olefin copolymers, likewise as a component in lubricant oil formulations. The copolymers are prepared by means of metallocene catalysts of the monocyclopentadienyl type.

Further amorphous poly-α-olefins that have been synthesized with metallocenes and are suitable for the lubricant oil sector, especially poly-1-decenes, are described in document U.S. Pat. No. 6,858,767B1.

Waxy copolymers of propylene and ethylene which have been prepared by means of metallocene catalysis and have semicrystalline character are known from EP 0384264A1.

The present invention provides pressure-sensitive adhesive compositions containing between 5% and 50% by weight of copolymers of propylene with ethylene and/or with olefins selected from the group of the higher 1-olefins C₄-C₂₀, where the copolymers have been prepared with the aid of metallocene catalysts and are characterized by
a flow point of <50° C., preferably <30° C., more preferably <25° C.,
a viscosity at 170° C. between 20 and 3000 mPa·s, preferably 50 to 1000 mPa·s, more preferably 80 to 500 mPa·s,
a density at 23° C. between 0.83 and 0.90, preferably 0.84 and 0.88, g/cm³,
a glass transition temperature determined by the DSC method of <−35° C., preferably <−40° C., more preferably <−45° C.

Flow point is determined to ASTM D97, viscosity with a rotary viscometer of the “cone/plate” design to DIN 53019, density to ISO 1183, and glass transition temperature by means of DSC to DIN EN ISO 11357-2:2014.

Higher 1-olefins used are linear or branched olefins having 4 to 20 carbon atoms and preferably having 4 to 6 carbon atoms. These olefins may have aromatic substitution conjugated to the olefinic double bond. Examples are 1-butene, 1-hexene, 1-octene or 1-octadecene, and styrene.

The copolymers contain between 70% and 95% by weight, preferably 75% to 85% by weight, of units formed from propylene. The proportion of the comonomer(s) is accordingly 5% to 30% by weight, preferably 15% to 25% by weight.

Preference is given to the copolymers of propylene with ethylene.

The copolymers are prepared using organometallic catalysts of the metallocene compound type. These contain titanium, zirconium or hafnium atoms as active species and are generally used in combination with co-catalysts, e.g. organoaluminum or boron compounds, preferably aluminoxane compounds. If required, the polymerization is effected in the presence of hydrogen as molar mass regulator. It is a feature of metallocene methods that, by comparison with the older Ziegler technology, it is possible to obtain polymers with narrower molar mass distribution, more homogeneous comonomer incorporation and higher catalyst effectiveness.

For the preparation of the metallocene polyolefins used in accordance with the invention, metallocene compounds of the formula (I) are used.

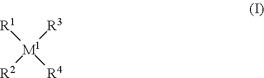

This formula also includes compounds of the formula (Ia)

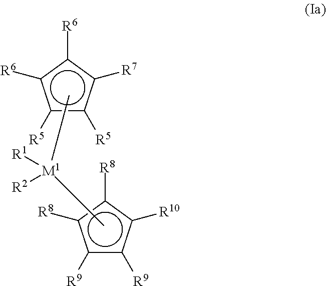

of the formula (Ib)

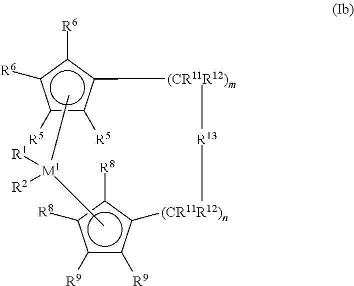

and of the formula (Ic)

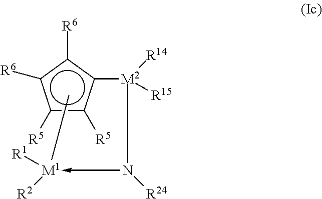

In the formulae (I), (Ia) and (Ib), M¹ is a metal from group IVb, Vb or VIb of the Periodic Table, for example titanium, zirconium, hafnium, vanadium, niobium, tantalum, chromium, molybdenum, tungsten, preferably titanium, zirconium and hafnium.

R¹ and R² are the same or different and are a hydrogen atom, a C₁-C₁₀- and preferably C₁-C₃-alkyl group, especially methyl, a C₁-C₁₀- and preferably C₁-C₃-alkoxy group, a C₆-C₁₀- and preferably C₆-C₈-aryl group, a C₆-C₁₀- and preferably C₆-C₈-aryloxy group, a C₂-C₁₀- and preferably C₂-C₄-alkenyl group, a C₂-C₄₀- and preferably C₂-C₁₀-arylalkyl group, a C₂-C₄₀- and preferably C₂-C₁₂-alkylaryl group, a C₈-C₄₀- and preferably C₈-C₁₂-arylalkenyl group or a halogen atom, preferably a chlorine atom.

R³ and R⁴ are the same or different and are a mono- or polyvalent hydrocarbyl radical that can form a sandwich structure with the central atom M. Preferably, R³ and R⁴ are cyclopentadienyl, indenyl, tetrahydroindenyl, benzoindenyl or fluorenyl, where the base skeletons may also bear additional substituents or be bridged to one another. Moreover, one of the R³ and R⁴ radicals may be a substituted nitrogen atom, where R²⁴ has the definition of R¹⁷ and is preferably methyl, tert-butyl or cyclohexyl.

R⁵, R⁶, R⁷, R⁸, R⁹ and R¹⁰ are the same or different and are a hydrogen atom, a halogen atom, preferably a fluorine, chlorine or bromine atom, a C₁-C₁₀- and preferably C₁-C₄-alkyl group, a C₆-C₁₀- and preferably C₆-C₈-aryl group, a C₁-C₁₀- and preferably C₁-C₃-alkoxy group, a —NR¹⁶₂—, —SR¹⁶—, —OSiR¹⁶₃—, —SiR¹⁶₃— or —PR¹⁶₂— radical, in which R¹⁶ is a C₁-C₁₀- and preferably C₁-C₃-alkyl group or C₆-C₁₀- and preferably C₆-C₈-aryl group, or else, in the case of Si- or P-containing radicals, a halogen atom, preferably a chlorine atom, or any two adjacent R⁵, R⁶, R⁷, R⁸, R⁹ or R¹⁰ radicals together with the carbon atoms that join them form a ring. Particularly preferred ligands are the substituted compounds of the cyclopentadienyl, indenyl, tetrahydroindenyl, benzoindenyl or fluorenyl base skeletons.

R¹³ is

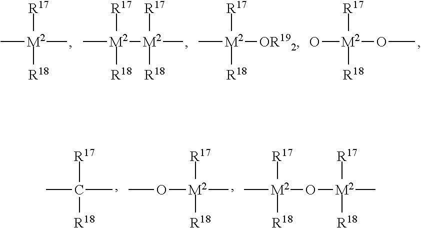

═BR¹⁷, =AlR¹⁷, —Ge—, —Sn—, —O—, —S—, =SO, =SO₂, =NR¹⁷, =CO, =PR¹⁷ or =P(O)R¹⁷, where R¹⁷, R¹⁸ and R¹⁹ are the same or different and are a hydrogen atom, a halogen atom, preferably a fluorine, chlorine or bromine atom, a C₁-C₃₀- and preferably C₁-C₄-alkyl group, especially methyl group, a C₁-C₁₀-fluoroalkyl group, preferably CF₃ group, a C₆-C₁₀-fluoroaryl group, preferably pentafluorophenyl group, a C₆-C₁₀- and preferably C₆-C₈-aryl group, a C₁-C₁₀- and preferably C₁-C₄-alkoxy group, especially methoxy group, a C₂-C₁₀- and preferably C₂-C₄-alkenyl group, a C₇-C₄₀- and preferably C₇-C₁₀-aralkyl group, a C₈-C₄₀- and preferably C₈-C₁₂-arylalkenyl group or a C₇-C₄₀- and preferably C₇-C₁₂-alkylaryl group, or R¹⁷ and R¹⁸ or R¹⁷ and R¹⁹ together with the atoms that join them form a ring.

M² is a silicon, germanium or tin, preferably silicon and germanium. R¹³ is preferably =CR¹⁷R¹⁸, =SiR¹⁷R¹⁸, =GeR¹⁷R¹⁸, —O—, —S—, =SO, =PR¹⁷ or =P(O)R¹⁷.

R¹¹ and R¹² are the same or different and have the definition given for R¹⁷. m and n are the same or different and are zero, 1 or 2, preferably zero or 1, where m plus n is zero, 1 or 2, preferably zero or 1.

R¹⁴ and R¹⁵ have the definition of R¹⁷ and R¹⁸.

Preference is given to metallocenes of type Ia and Ib, more preferably those of type Ib, especially preferably Ib metallocenes with symmetric structure, i.e. identical aromatic ligands.

Examples of suitable metallocenes are:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methyl-cyclopentadienyl)zirconium dichloride,
bis(2-methyl-4,6-diisopropylindenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium dichloride,
bis(indenyl)zirconium dichloride,
bis(methylcyclopentadienyl)zirconium dichloride,
bis(n-butylcyclopentadienyl)zirconium dichloride,
bis(octadecylcyclopentadienyl)zirconium dichloride,
bis(pentamethylcyclopentadienyl)zirconium dichloride,
bis(trimethylsilylcyclopentadienyl)zirconium dichloride,
biscyclopentadienylzirconium dibenzyl,
biscyclopentadienylzirconium dimethyl,
bistetrahydroindenylzirconium dichloride,
dimethylsilyl-9-fluorenylcyclopentadienylzirconium dichloride,
dimethylsilylbis-1-(2,3,5-trimethylcyclopentadienyl)-zirconium dichloride,
dimethylsilylbis-1-(2,4-dimethyl-cyclopentadienyl)-zirconium dichloride,
dimethylsilylbis-1-(2-methyl-4,5-benzoindenyl)-zirconium dichloride,
dimethylsilylbis-1-(2-methyl-4-ethylindenyl)zirconium dichloride,
dimethylsilylbis-1-(2-methyl-4-i-propylindenyl)-zirconium dichloride,
dimethylsilylbis-1-(2-methyl-4-phenylindenyl)zirconium dichloride,
dimethylsilylbis-1-(2-methylindenyl)zirconium dichloride,
dimethylsilylbis-1-(2-methyltetrahydroindenyl)-zirconium dichloride,
dimethylsilylbis-1-indenylzirconium dichloride,
dimethylsilylbis-1-indenylzirconium dimethyl,
dimethylsilylbis-1-tetrahydroindenylzirconium dichloride,
diphenylmethylene-9-fluorenylcyclopentadienylzirconium dichloride,
diphenylsilylbis-1-indenylzirconium dichloride,
ethylenebis-1-(2-methyl-4,5-benzoindenyl)zirconium dichloride,
ethylenebis-1-(2-methyl-4-phenylindenyl)zirconium dichloride,
ethylenebis-1-(2-methyltetrahydroindenyl)zirconium dichloride,
ethylenebis-1-(4,7-dimethylindenyl)zirconium dichloride,
ethylenebis-1-indenylzirconium dichloride,
ethylenebis-1-tetrahydroindenylzirconium dichloride,
indenylcyclopentadienylzirconium dichloride,
isopropylidene(1-indenyl) (cyclopentadienyl)zirconium dichloride,
isopropylidene(9-fluorenyl) (cyclopentadienyl)zirconium dichloride,
phenylmethylsilyl-bis-1-(2-methylindenyl)zirconium dichloride,
and the respective alkyl or aryl derivatives of these metallocene dichlorides.

The single-center catalyst systems are activated using suitable cocatalysts. Suitable cocatalysts for metallocenes of the formula (I) are organoaluminum compounds, especially aluminoxanes, or else aluminum-free systems such as R²⁰ₓNH₄₋ₓBR²¹₄, R²⁰), R²¹₄, R²⁰₃CBR²¹₄ or BR²¹₃. In these formulae, x is a number from 1 to 4, the R²⁰ radicals are the same or different, preferably the same, and are C₁-C₁₀-alkyl or C₆-C₁₈-aryl, or two R²⁰ radicals together with the atom that joins them form a ring, and the R²¹ radicals are the same or different, preferably the same, and are C₆-C₁₈-aryl which may be substituted by alkyl, haloalkyl or fluorine. More particularly, R²⁰ is ethyl, propyl, butyl or phenyl and R²¹ is phenyl, pentafluorophenyl, 3,5-bis(trifluoro-methyl)phenyl, mesityl, xylyl or tolyl.

In addition, a third component is frequently required to ensure protection from polar catalyst poisons.

Suitable for this purpose are organoaluminum compounds, for example triethylaluminum, tributylaluminum and others, and also mixtures of these.

According to the method, it is also possible to use supported single-center catalysts. Preference is given to using catalyst systems in which the residual contents of support material and cocatalyst do not exceed a concentration of 100 ppm in the product.

Depending on their properties, the poly-1-olefins in the pressure-sensitive adhesive formulation may exert either the function of a base polymer or that of a plasticizer or tackifier.

The polyolefins may be used in unchanged or in polar-modified form in the pressure-sensitive adhesive. Polar-modified polymers are prepared in a known manner from nonpolar polymers by oxidation with oxygenous gases, for example air, or by free-radical graft reaction with polar monomers, for example α,β-unsaturated carboxylic acids or derivatives thereof, such as acrylic acid, maleic acid, or maleic anhydride, or unsaturated organosilane compounds such as trialkoxy-vinylsilanes. The polar modification of metallocene polyolefins by oxidation with air is described, for example, in EP 0890583A1, and modification by grafting, for example, in U.S. Pat. No. 5,998,547A.

The poly-1-olefins are present in the formulations used as pressure-sensitive adhesive with a proportion by weight between 5% and 50%, preferably between 10% and 40%, more preferably between 20% and 35%.

The pressure-sensitive adhesives contain additional components as well as the poly-1-olefin copolymers of the invention that have been prepared with metallocene catalysts. Useful examples include:
Further polyolefins: this is understood to mean polyolefins beyond the 1-olefin copolymers of the invention. The further polyolefins are obtained by polymerization of any nonpolar or polar, unbranched or branched olefins or combinations of these. Examples include polyolefins prepared by cationic, anionic or insertion mechanisms or polar or nonpolar polyolefins of polar and/or nonpolar monomers that have been synthesized by free-radical high-pressure methods. Preference is given to nonpolar polyolefins prepared using Ziegler-Natta or metallocene catalysts. Especially suitable are low molecular weight semicrystalline homo- or copolymers as traded, for example, under the Licocene® name by the manufacturer Clariant. Also preferred are copolymers of ethylene with propylene or else higher α-olefins such as butene-1 or octene-1, known for instance under trade names such as Versify®, Infuse®, Affinity® or Engage® (Dow Chemical Corp.) or Vistamaxx® or Exxact® (Exxon Mobil Chemical). Also preferred are block copolymers of styrene and dienes such as isoprene or butadiene, optionally with proportions of ethylene (SIS, SBS, SEBS). Also preferred are what are called amorphous poly-alpha-olefins (APAOs), atactic polypropylene (APP) or polyisobutene (PIB).
Resins: available resins include, for example, what are called aliphatic and cycloaliphatic or aromatic hydrocarbon resins. These can be prepared by polymerization of particular resin oil fractions obtained in the processing of mineral oil. Resins of this kind that can be modified, for example, by hydrogenation or functionalization are available, for example, under the trade names Eastoflex®, RegalREZ®, Kristalex®, Eastotac®, Piccotac® (Eastman Chemical Company) or Escorez® (ExxonMobil Chemical Company).
Further useful resins include polyterpene resins prepared by polymerization of terpenes, for example pinene, in the presence of Friedel-Crafts catalysts, and likewise hydrogenated polyterpenes, copolymers and terpolymers of natural terpenes, for example styrene/terpene or α-methyl-styrene/terpene copolymers. Also useful are natural and modified rosins, especially resin esters, glycerol esters of tree resins, pentaerythritol esters of tree resins and tall oil resins and the hydrogenated derivatives thereof, and phenol-modified pentaerythritol esters of resins and phenol-modified terpene resins;
Natural or synthetic rubbers, polyacrylates, polyesters, polychloroprenes, polyvinyl ethers or polyurethanes;
Further components such as plasticizers, nonpolar waxes such as polyethylene or polypropylene waxes or paraffin waxes such as Fischer-Tropsch paraffins, micro- or macrocrystalline paraffins, polar waxes, for example oxidized or polar olefin-grafted polyolefin waxes or ethylene-vinyl acetate copolymer waxes or ethylene-acrylic acid copolymer waxes, and also organic or inorganic pigments, fillers and stabilizers, e.g. antioxidants and light stabilizers.

The examples which follow are intended to further illustrate the invention but without restricting it.

### EXAMPLE 1

Preparation of a propylene ethylene copolymer of the invention (in accordance with EP 0384264A1, examples 1-16)

A dry 16 dm³ tank was purged with nitrogen and charged with 50 dm³ (STP) (corresponding to 3.1 bar) of hydrogen and with 10 dm³ of liquid propylene. Then 30 cm³ of toluenic methylaluminoxane solution (corresponding to 40 mmol of Al, average degree of oligomerization of the methylaluminoxane n=20) and 100 g of ethylene were added, and the mixture was stirred at 30° C. for 15 minutes.

In parallel, 8.0 mg of the metallocene dimethylsilyl-bis(1-indenylzirconium dichloride) were dissolved in 15 cm³ of toluenic methylaluminoxane solution (20 mmol of Al) and pre-activated by leaving it to stand for 15 minutes. The orange-red solution was introduced into the tank. The polymerization system was brought to 80° C. and kept at this temperature by appropriate cooling during the polymerization time (60 min). During the polymerization time, a further 330 g of ethylene were metered in homogeneously.

The resultant propylene-ethylene copolymer (yield 1.95 kg) had a propylene content of 79.5% by weight. The determination was made by ¹³C NMR spectroscopy according to Ser van der Ven, Polypropylene and other Polyolefins, ch. 13, p. 568 ff., Amsterdam, Oxford, New York, Tokyo 1990. The copolymer showed the following indices:

Viscosity at 170° C.: 210 mPa·s;

Density at 23° C.: 0.85 g/cm³;

Flow point: 21° C.;

Glass transition temperature: −48° C.

Performance Tests

Mixtures were produced according to tables 1 and 2. For this purpose, the stated components were stirred homogeneously with one another at about 170° C. in the molten state in the proportions by weight specified. The molten mass (about 150 g) was divided into two roughly equal portions on silicone-coated paper. One portion was introduced into the melt tank of a roll application machine of the Thermo 150 type (manufacturer: Hardo Maschinenbau GmbH) and discharged again after 5 minutes (preliminary flush of the machine). The second portion served to coat a glass plate (5×20 cm). The coat weight was determined by weighing. The glass plate was stored with the coated side downward on a silicone paper at room temperature for about 1 week. Then the coated side was bonded to a polyester film and compressed by pulling and pushing a contact roller over the bond 10 times with a load of 5 kg. Subsequently, the bonded test specimen was clamped into a peel tester (manufacturer: Zwick Roell), and the peel value was ascertained to DIN EN 1464, June 2010 (dry peel test).

TABLE 1
Application examples (inventive)/(use amounts in % by weight)

| | | AE 1 | AE 2 | AE 3 | AE 4 | AE 5 | AE 6 | AE 7 | AE 8 | AE 9 | AE 10 | AE 11 | AE 12 |
|---|---|---|---|---|---|---|---|---|---|---|---|---|---|
| Propylene-ethylene | | 30 | 30 | 30 | 30 | 30 | 30 | 30 | 30 | 30 | 30 | 30 | 30 |
| copolymer according | | | | | | | | | | | | | |
| to ex. 1 | | | | | | | | | | | | | |
| Vestoplast ® 828 | | | | 15 | | | | | | | | | |
| Vestoplast ® 888 | | | | | 15 | | | | | | | | |
| Eastoflex ® 1060 | | | | | | 15 | | | | | | | |
| Versify ® DE 4301.01 | | | | | | | 15 | 15 | | 5 | | | |
| Licocene ® PP 1602 | | | | | | | | | 15 | | | | |
| Vistamaxx ® 6102 | | | | | | | | | | 10 | | | |
| Infuse ® 9807 | | 15 | | | | | | | | | | | |
| Infuse ® 9817 | | | 15 | | | | | | | | | | |
| Engage ® 8407 | | | | | | | | | | | 20 | 15 | 10 |
| Sukorez ® SU 100 | | 55 | 55 | 55 | 55 | 55 | 55 | | 55 | 55 | 55 | 55 | 55 |
| Dertophene ® T | | | | | | | | 55 | | | | | |
| Melt | [mPa · s] | 3989 | 4265 | 1255 | 16570 | 610 | 14500 | 8200 | 937 | 43000 | 10500 | 3790 | 3200 |
| viscosity | | | | | | | | | | | | | |
| (150° C.) | | | | | | | | | | | | | |
| Peel value | [N/mm] | 0.9 | 0.53 | 1.12 | 1.11 | 0.91 | 0.85 | 0.97 | 0.47 | 0.54 | 0.70 | 0.66 | 0.62 |
| immediate | | | | | | | | | | | | | |

TABLE 2
Use examples (noninventive)/(use amounts in % by weight)

| | AV 1 | AV 2 | AV 3 | AV 4 |
|---|---|---|---|---|
| Propylene-ethylene copolymer | — | — | 55 | 70 |
| according to example 1 | | | | |
| Versify ® DE 4301.01 | 15 | | 15 | 15 |
| Engage ® 8407 | | 15 | | |
| Sukorez ® SU 100 | 55 | 55 | 30 | 15 |
| Regalite ® 1010 | 20 | 20 | | |
| Shell Catenex ® T145 | 10 | 10 | | |
| Melt viscosity (150° C.) [mPa · s] | 4000 | 1500 | 7000 | 5000 |
| Peel value immediate [N/mm] | 0.20 | 0.34 | 0.21 | 0 |

Raw Materials Used:

Vestoplast® and Eastoflex® are amorphous poly-α-olefins (APAOs) from Evonik and Eastman respectively.

Versify®, Infuse® and Engage® and Vistamaxx® are ethylene copolymers from the manufacturers Dow and ExxonMobil respectively.

Licocene® PP 1602 is a propylene-ethylene copolymer from the manufacturer Clariant.

Sukorez® SU 100 and Regalite® 1010 are hydrogenated hydrocarbon resins from the manufacturers Kolon Ind. and Eastman respectively; Dertophen T is a terpene-phenol resin from the manufacturer DRT.

Catenex® T145 is a paraffin oil from Shell.

1. A pressure-sensitive adhesive composition containing 5% to 50% by weight of copolymers of propylene with ethylene and/or with olefins selected from the group of the 1-olefins having 4 to 20 carbon atoms, where the copolymers have been prepared with the aid of metallocene catalysts and are characterized by
a) a flow point, measured to ASTM D97, of <50° C.,
b) a viscosity at 170° C. in the range from 20 to 3000 mPa·s, measured with a rotary viscometer to DIN 53019,
c) a density in the range from 0.84 to 0.90 g/cm³, measured at 23° C. to ISO 1183,
d) a glass transition temperature of <−35° C., measured by the DSC method to DIN EN ISO 11357-2:2014.

2. The pressure-sensitive adhesive composition as claimed in claim 1, wherein the 1-olefin copolymers consist to an extent of 70-95% by weight of the propylene structural unit and to an extent of 5-30% by weight of structural units selected from ethylene and/or the group of the 1-olefins having 4 to 20 carbon atoms.

3. The pressure-sensitive adhesive composition as claimed in claim 1, wherein the 1-olefin copolymers consist to an extent of 70-95% by weight of the propylene structural unit and to an extent of 5-30% by weight of the ethylene structural unit.

4. The pressure-sensitive adhesive composition as claimed in claim 1, wherein the copolymers of propylene have polar modification.

5. The pressure-sensitive adhesive composition as claimed in claim 1, containing 50-95% by weight of one or more components selected from the group of the further polyolefins, the resins, the waxes, the plasticizers, the natural or synthetic rubbers, polyacrylates, polyesters, polychloroprenes, polyvinyl ethers or polyurethanes, the pigments, the fillers, the stabilizers and the antioxidants.

6. The use of pressure-sensitive adhesives as claimed in claim 1 for bonding of adherends.
